(19) United States
(12) Patent Application Publication
(10) Pub. No.: US 2024/0330817 A1
(43) Pub. Date: Oct. 3, 2024

(54) SYSTEM AND METHOD TO PROVIDE RISK RELATIONSHIP ENTITY INTERACTION TRACKER

(71) Applicant: David F. Whitehead, Lake Mary, FL (US)

(72) Inventor: David F. Whitehead, Lake Mary, FL (US)

(21) Appl. No.: 18/192,196

(22) Filed: Mar. 29, 2023

(51) Int. Cl. G06Q 10/0635

(52) U.S. Cl. CPC G06Q 10/0635

(57) ABSTRACT

An entity interaction data store contains electronic records associated with interaction identifiers. For each interaction identifier, the data store includes an account identifier, an entity identifier, and interaction parameters. A risk relationship data store contains electronic records for accounts having risk relationships with an enterprise. A back-end application computer server may associate selected interaction identifiers in the entity interaction data store with selected accounts having risk relationships with the enterprise. The computer server may then retrieve interaction parameters from the entity interaction data store and risk relationship parameters from the risk relationship data store and provide the retrieved interactions parameters to an enterprise predictive model that outputs an interaction insight result. The computer server may also facilitate an exchange of data with a remote device to support interactive user interface displays that include information about the interaction insight result.

### TECHNICAL FIELD

The present application generally relates to computer systems and more particularly to computer systems that are adapted to accurately, securely, and/or automatically track entity interactions for a risk relationship enterprise.

### BACKGROUND

An enterprise may enter into relationships with various parties. For example, an insurer might enter into risk relationships (e.g., insurance agreements) with various accounts or businesses. In some cases, insurance agreements may be associated with entities or customers, such as employees of a business. For example, an insurer may process Short Term Disability (“STD”) or paid family leave requests for employees. Processing such requests may involve interaction experiences or events with employees (e.g., to handle inquiries, payments, date changes, etc.). It may therefore be desirable to track the interactions to evaluate performance and/or gain insights about potential problems or improvements.

It would be desirable to provide improved systems and methods to accurately and/or automatically provide entity interaction tracking tools for an enterprise. Moreover, the results should be easy to access, understand, interpret, update, etc.

### SUMMARY OF THE INVENTION

According to some embodiments, systems, methods, apparatus, computer program code and means are provided to accurately and/or automatically provide risk relationship tools for an enterprise in a way that provides fast, secure, and useful results and that allows for flexibility and effectiveness when responding to those results.

Some embodiments are directed to a tracking tool implemented via a back-end application computer server. An entity interaction data store may contain electronic records associated with interaction identifiers. For each interaction identifier, the data store includes an account identifier, an entity identifier, and interaction parameters. A risk relationship data store contains electronic records for accounts having risk relationships with an enterprise. A back-end application computer server may associate selected interaction identifiers in the entity interaction data store with selected accounts having risk relationships with the enterprise. The computer server may then retrieve interaction parameters from the entity interaction data store and risk relationship parameters from the risk relationship data store and provide the retrieved interactions parameters to an enterprise predictive model that outputs an interaction insight result. The computer server may also facilitate an exchange of data with a remote device to support interactive user interface displays that include information about the interaction insight result.

Some embodiments comprise: means for associating, by a computer processor of the back-end application computer server, selected interaction identifiers in an entity interaction data store with selected accounts having risk relationships with an enterprise, wherein the entity interaction data store contains electronic records associated with a plurality of interaction identifiers, and, for each interaction identifier, an account identifier, an entity identifier, and interaction parameters; based on the selected interaction identifiers, means for retrieving, by a computer processor of the back-end application computer server, interaction parameters from the entity interaction data store and risk relationship parameters from the risk relationship data store; means for providing the retrieved interactions parameters to an enterprise predictive model that outputs an interaction insight result; and means for exchanging data with a remote device to support interactive user interface displays that include information about the interaction insight result.

In some embodiments, a communication device associated with a back-end application computer server exchanges information with remote devices in connection with interactive graphical user interfaces. The information may be exchanged, for example, via public and/or proprietary communication networks.

A technical effect of some embodiments of the invention is improved and computerized entity interaction tracking tools for an enterprise that provide fast, secure, and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 shows various enterprise risk relationships according to some embodiments.

FIG. 2 is a high-level block diagram of an interaction tracking system in accordance with some embodiments.

FIG. 3 illustrates a high-level method according to some embodiments.

FIG. 4 is a customer experience tracker event data entry display in accordance with some embodiments.

FIG. 5 is a smartphone showing an issue resolution interface according to some embodiments.

FIG. 6 is an all item view display in accordance with some embodiments.

FIG. 7 is an escalation resolution team view display according to some embodiments.

FIG. 8 is a customer experience and insights dashboard twelve month display in accordance with some embodiments.

FIG. 9 is a daily activity display according to some embodiments.

FIG. 10 is a product view display in accordance with some embodiments.

FIG. 11 is an account (e.g., national, regional, priority, etc.) view display according to some embodiments.

FIG. 12 is a customer sentiment display in accordance with some embodiments.

FIG. 13 is a time-to-resolution display according to some embodiments.

FIG. 14 is a processing view display in accordance with some embodiments.

FIG. 15 is a case view display according to some embodiments.

FIGS. 16 and 17 illustrate drill down options in accordance with some embodiments.

FIG. 18 is an event data display in accordance with some embodiments.

FIG. 19 is a more detailed system according to some embodiments.

FIG. 20 is an automatically generated entity interaction communication according to some embodiments.

FIG. 21 is a block diagram of an apparatus in accordance with some embodiments.

FIG. 22 is a portion of a tabular entity interaction data store according to some embodiments.

FIG. 23 is an operator or administrator display in accordance with some embodiments.

FIG. 24 illustrates a system having a predictive model in accordance with some embodiments.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data processing associated with risk relationships. The present invention is directed to more than merely a computer implementation of a routine or conventional activity previously known in the industry as it provides a specific advancement in the area of electronic record analysis by providing improvements in the operation of a computer system that customizes risk relationships (including those associated with insurance interactions). The present invention provides improvement beyond a mere generic computer implementation as it involves the novel ordered combination of system elements and processes to provide improvements in the speed, security, and accuracy of an interaction tracking tool for an enterprise. Some embodiments of the present invention are directed to a system adapted to automatically customize and execute interaction insights, aggregate data from multiple data sources, automatically optimize interaction information to reduce unnecessary messages or communications, etc. (e.g., to consolidate or coordinate information). Moreover, communication links and messages may be automatically established, aggregated, formatted, modified, removed, exchanged, etc. to improve network performance (e.g., by reducing an amount of network messaging bandwidth and/or storage required to create generate interaction messages or alerts, improve security, reduce the size of an entity interaction data store, more efficiently collect escalation details, etc.).

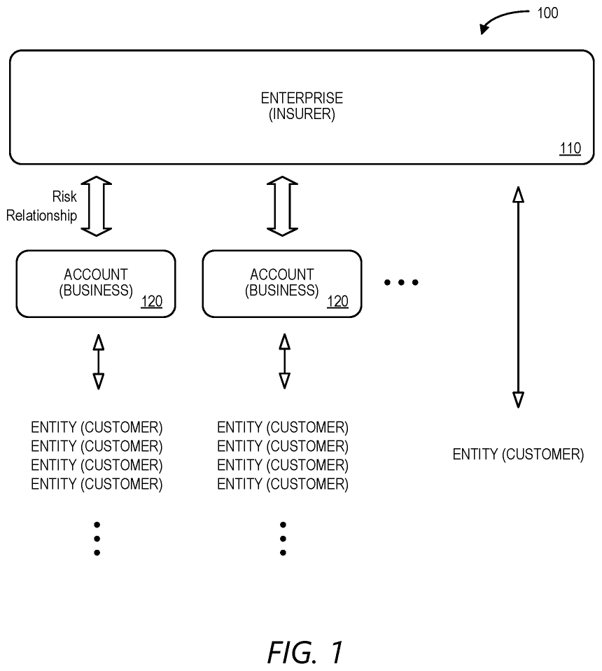

FIG. 1 shows various enterprise risk relationships 100 according to some embodiments. In particular, an enterprise 110, such as an insurance company, may have risk relationships (e.g., insurance agreements or policies) associated with accounts 120 (such as business). For example, an insurance company may offer workers' compensation or STD insurance to businesses. Each account 120 might be associated with one or more entities (e.g., various employees or customers of the enterprise 110 and/or accounts 120).

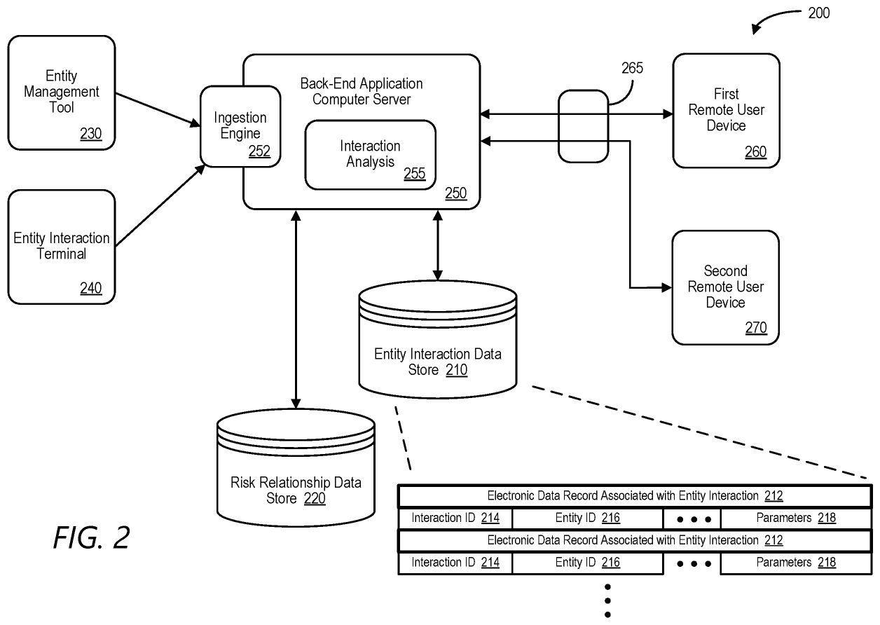

FIG. 2 is a high-level block diagram of an interaction tracking system 200 that may be provided according to some embodiments of the present invention. In particular, the system 200 includes a back-end application computer server 250 that may access information in an entity interaction data store 210 (e.g., storing a set of electronic records associated with various entity interactions 212, each record including, for example, one or more interaction identifiers 214, entity identifiers 216, interaction parameters 218, etc.). The back-end application computer server 250 may also store information into other data stores, such as a risk relationship data store 220, and utilize an ingestion engine 252 and interaction algorithm 255 to exchange and process messages (e.g., daily/weekly data sweeps or on-demand changes) and view, analyze, and/or update the electronic records. The back-end application computer server 250 may also exchange information with a first remote user device 260 and a second remote user device 270 (e.g., via a firewall 265). According to some embodiments, an interactive graphical user interface platform of the back-end application computer server 250 may facilitate interaction summaries, recommendations, alerts, and/or the display of insight results via one or more remote administrator computers (e.g., to summarize system 200 performance) and/or the remote user devices 260, 270. For example, the first remote user device 260 may transmit annotated and/or updated information to the back-end application computer server 250 (e.g., updating an event or interaction with a customer). Based on the updated information, the back-end application computer server 250 may adjust data in the entity interaction data store 210 and/or the risk relationship data store 220 and the change may (or may not) be used in connection with the second remote user device 270 (e.g., depending on whether the two users are associated with the same account). Note that the back-end application computer server 250 and/or any of the other devices and methods described herein might be associated with a third party, such as a vendor that performs a service for an enterprise. In some cases, the ingestion engine 252 may receive information from one or more entity management tools 230 (e.g., via POWER APPS® or SHAREPOINT® available from MICROSOFT®) and/or entity interaction terminals 240 (e.g., customer relations terminals).

The back-end application computer server 250 and/or the other elements of the system 200 might be, for example, associated with a Personal Computer (“PC”), laptop computer, smartphone, an enterprise server, a server farm, and/or a database or similar storage devices. According to some embodiments, an “automated” back-end application computer server 250 (and/or other elements of the system 200) may facilitate the automated access and/or update of electronic records in the data stores 210, 220 and/or the tracking of customer interactions and experiences. As used herein, the term “automated” may refer to, for example, actions that can be performed with little (or no) intervention by a human.

Devices, including those associated with the back-end application computer server 250 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 250 may store information into and/or retrieve information from the entity interaction data store 210 and/or the risk relationship data store 220. The data stores 210, 220 may be locally stored or reside remote from the back-end application computer server 250. As will be described further below, the entity interaction data store 210 may be used by the back-end application computer server 250 in connection with an interactive user interface to access and update electronic records. Although a single back-end application computer server 250 is shown in FIG. 2, any number of such devices may be included. Moreover, various devices described herein might be combined according to embodiments of the present invention. For example, in some embodiments, the back-end application computer server 250 and entity interaction data store 210 might be co-located and/or may comprise a single apparatus.

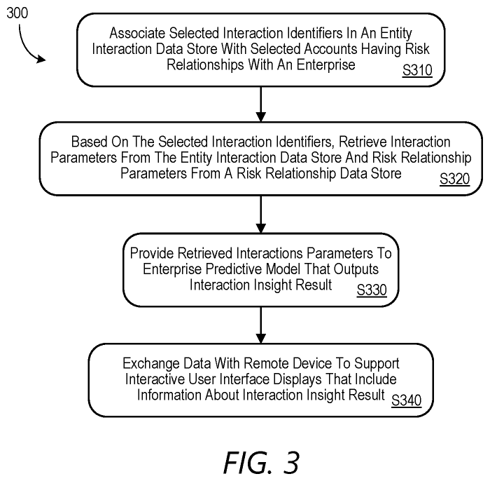

The elements of the system 200 may work together to perform the various embodiments of the present invention. Note that the system 200 of FIG. 2 is provided only as an example, and embodiments may be associated with additional elements or components. According to some embodiments, the elements of the system 200 automatically transmit information associated with an interactive user interface display over a distributed communication network. FIG. 3 illustrates a method 300 that might be performed by some or all of the elements of the system 200 described with respect to FIG. 2, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, a computer processor of the back-end application computer server may associate selected interaction identifiers in an entity interaction data store with selected accounts having risk relationships with an enterprise (e.g., an insurance company). The entity interaction data store may, for example, contains electronic records associated with a plurality of interaction identifiers, and, for each interaction identifier, an account identifier, an entity identifier (e.g., a customer name), and interaction parameters. As used herein, the phrase “interaction parameters” might refer to any experience or event between the enterprise and a customer. Examples of interaction parameters include a date, an issue category and subcategory, a line of business, an issue description, an analyst name, an entity sentiment (e.g., angry or neutral), an urgency level, a status, update information, an entity support assignment, an attachment (e.g., a medical record), etc. Other examples of interaction parameters may include a root cause category, resolution details, an interaction escalation (e.g., assigned to a team leader and/or analyst) and an interaction escalation driver (e.g., a date change, a delay, a payment issue, an employer inquiry, a notification error, a processing issue, or a service concern).

Based on the selected interaction identifiers, the computer server may retrieve interaction parameters from the entity interaction data store and risk relationship parameters from the risk relationship data store at S320. At S330, the system may provide the retrieved interactions parameters to an enterprise predictive model that outputs an interaction insight result. The system can then, at S340, exchange data with a remote device to support interactive user interface displays that include information about the interaction insight result. The interaction insight results might be associated with, for example, customer leave requests such as those for absence management, workers' compensation, STD, Long Term Disability (“LTD”), paid family leave, etc.

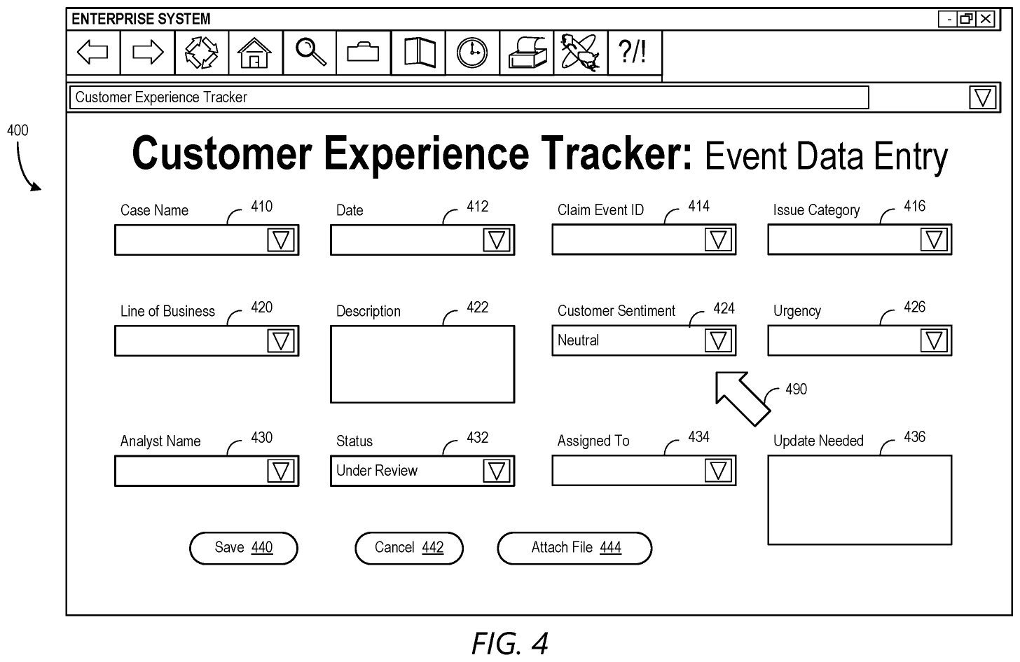

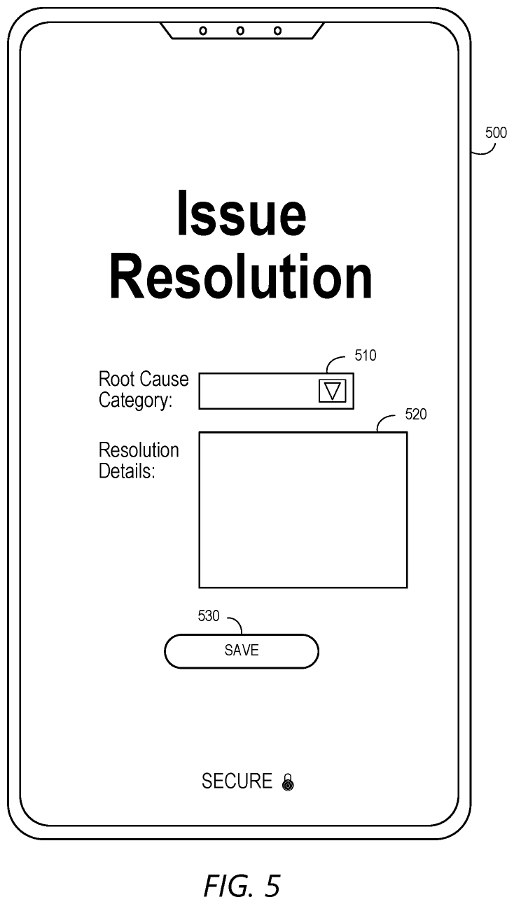

In this way, the system may facilitate the tracking and analysis of customer interactions via interactive user interfaces and dashboards. For example, FIG. 4 is a customer experience tracker event data entry display 400 in accordance with some embodiments. The display 400 includes fields to enter a case name 410, a date 412, a claim event identifier 414, and an issue category 416. The display 400 further includes fields to enter a line of business 420, an event description 422, a customer sentiment 424, an urgency 426, an analyst name 430, a status 432, an assignment 434, and an update needed description 436. A user may also select (e.g., via a touchscreen or computer mouse pointer 490) a “Save” icon 440, a “Cancel” icon 442, and an “Attach File” icon 444 (e.g., to upload medical documentation). Although the display 400 illustrated in FIG. 4 is provided via a web browser interface, note that embodiments may incorporate other interactions. For example, FIG. 5 is a smartphone 500 executing an application with an issue resolution interface to enter an escalation root cause category 510 and resolution details 520 (and a “Save” icon 530) according to some embodiments.

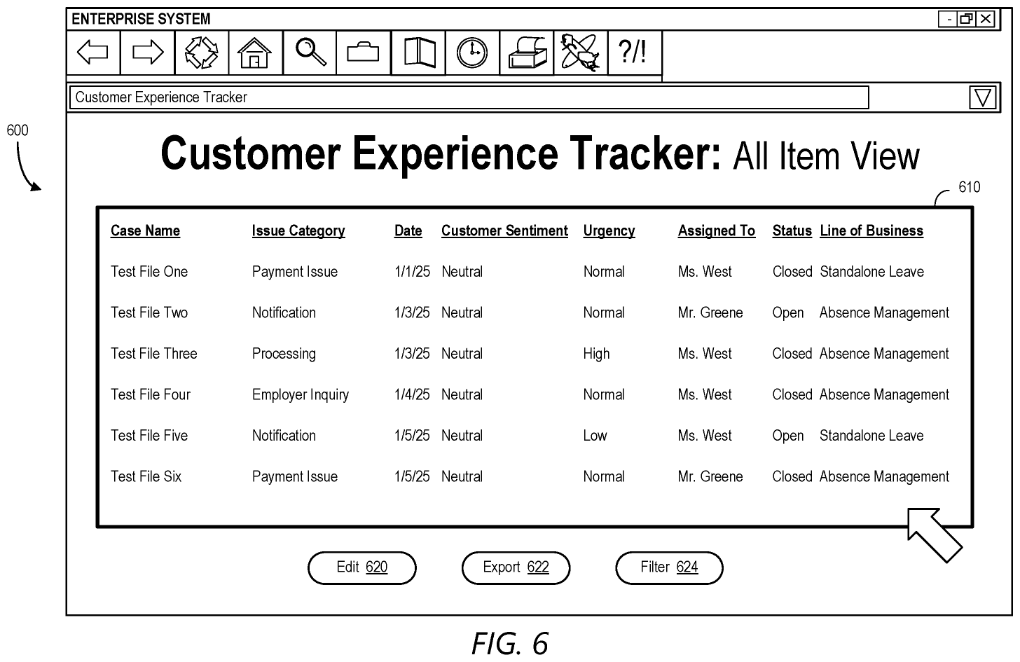

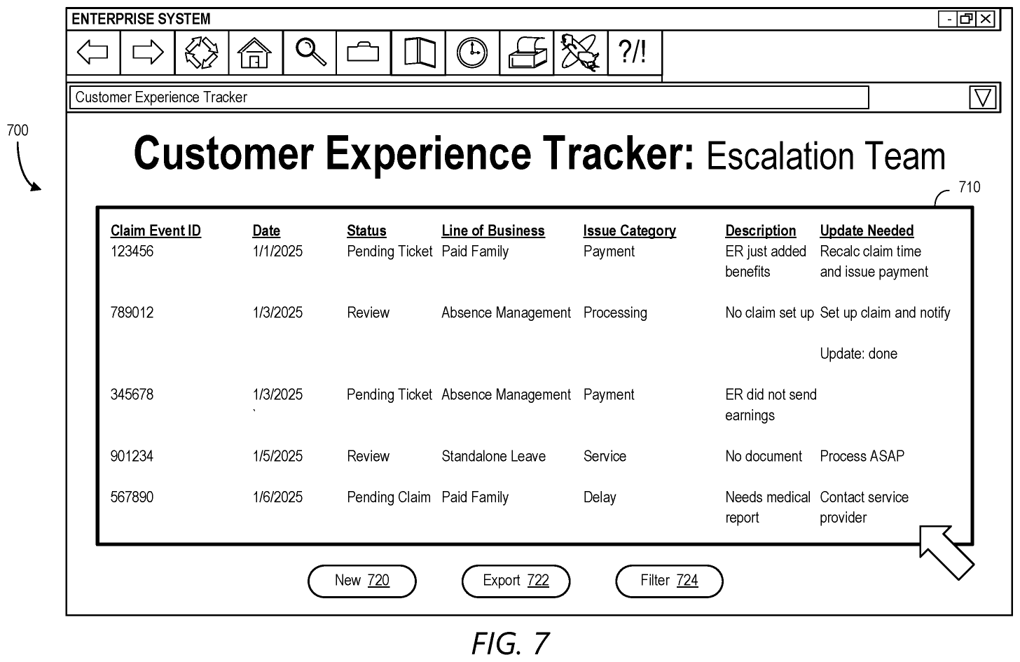

FIG. 6 is an all item view display 600 in accordance with some embodiments. The display 600 includes a table 610 showing, for a plurality of case names, an issue category, a date, a customer sentiment, an urgency, an assignment, a status, a line of business, etc. The display 600 also lets a user select an “Edit” icon 620 (e.g., to update the table 610), an “Export” icon 622 (e.g., to save data in a spreadsheet application format), and a “Filter” icon 624 (e.g., to only show items within a certain date range). Similarly, FIG. 7 is an escalation resolution team view display 700 according to some embodiments. The display 700 includes a table 710 showing, for a plurality of escalation claim event identifiers, a date, a status, a line of business, an issue category, a description, an update needed description, etc. The display 700 also lets a user select a “New” icon 720 (e.g., to add an escalation to the table 710), an “Export” icon 722 (e.g., to save data in a word processing application format), and a “Filter” icon 724 (e.g., to only show event escalations for a particular issue category).

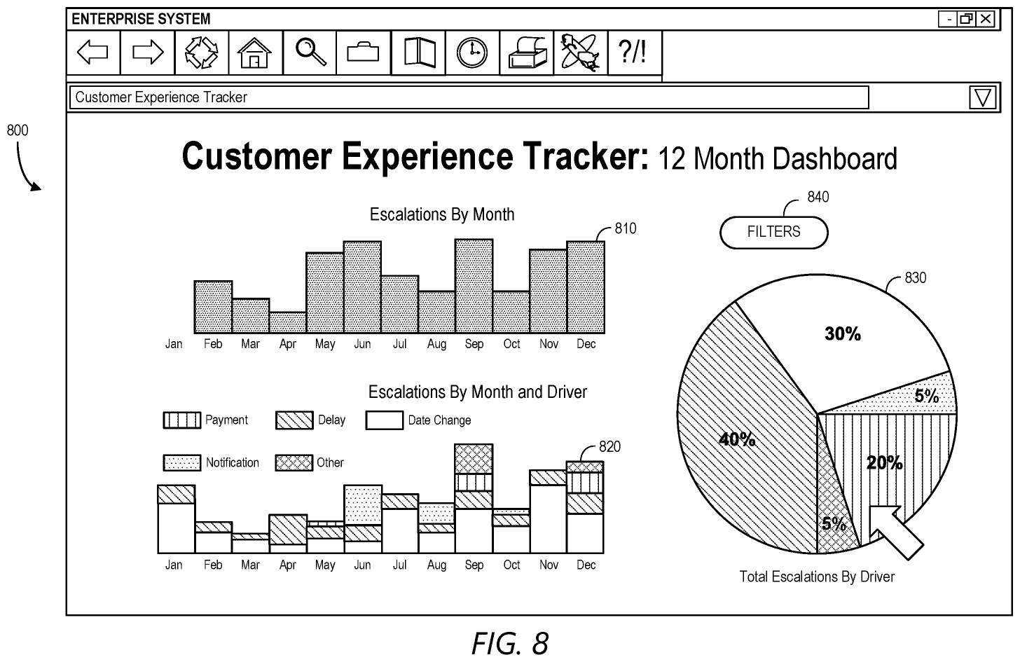

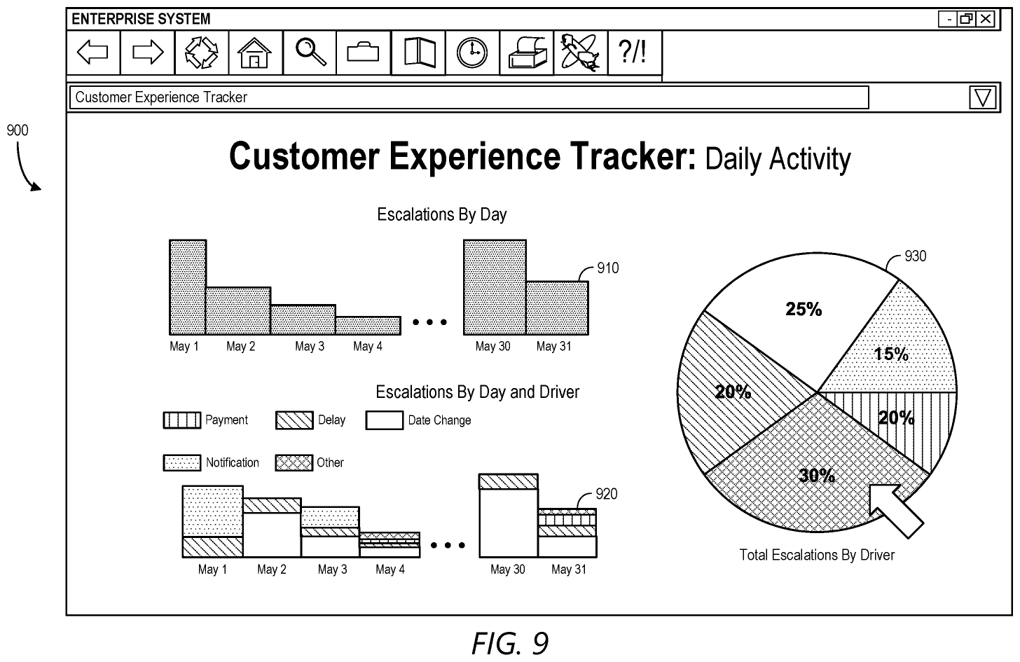

Embodiments may provide interaction tracking information to a user in any number of different ways. For example, FIG. 8 is a customer experience and insights dashboard twelve month display 800 in accordance with some embodiments. The display 800 provides a macro view of customer experiences and insights and includes bar charts showing escalations by month 810 and escalations by month and driver 820 (e.g., the driver might comprise a payment issue, a delay, a notification, etc.) and a pie chart showing total escalations by driver 830. A “Filter” icon 840 may, for example, let a user view escalations associated with a particular month or analyst. Similarly, FIG. 9 is a daily activity display 900 according to some embodiments. The display 900 includes bar charts showing escalations by day 910 and escalations by day and driver 920 and a pie chart showing total escalations by driver 930. Although the charts 910, 920 illustrated in FIG. 9 show activity for a month broken down by day (e.g., “May 1” through “May 31”), note that embodiments may show information broken down by any other increment (e.g., hourly, weekly, monthly, quarterly, etc.) or period of time (e.g., daily, weekly, etc.).

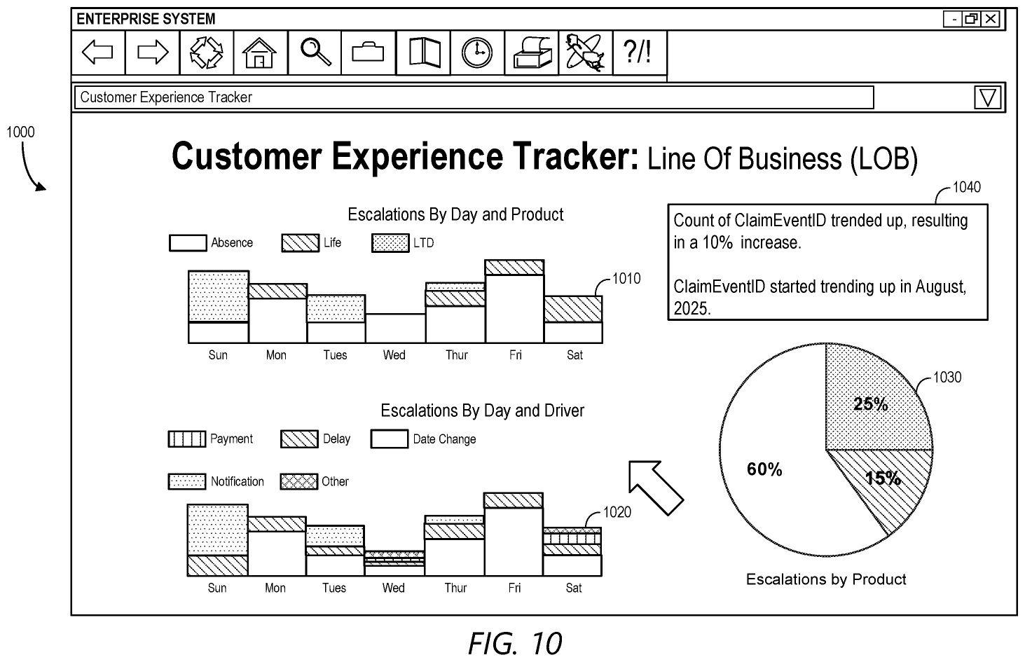

FIG. 10 is a product view or line of business display 1000 (e.g. to help analyze various types of insurance claims or leave requests) in accordance with some embodiments. The display 1000 includes bar charts showing escalations by day and product 1010 and escalations by day and driver 1020 and a pie chart showing total escalations by product 1030. According to some embodiments, the display 1000 also includes insights 1040, such as those identifying interaction trends, alerts, suggestions, predictions, etc. as generated by a predictive model.

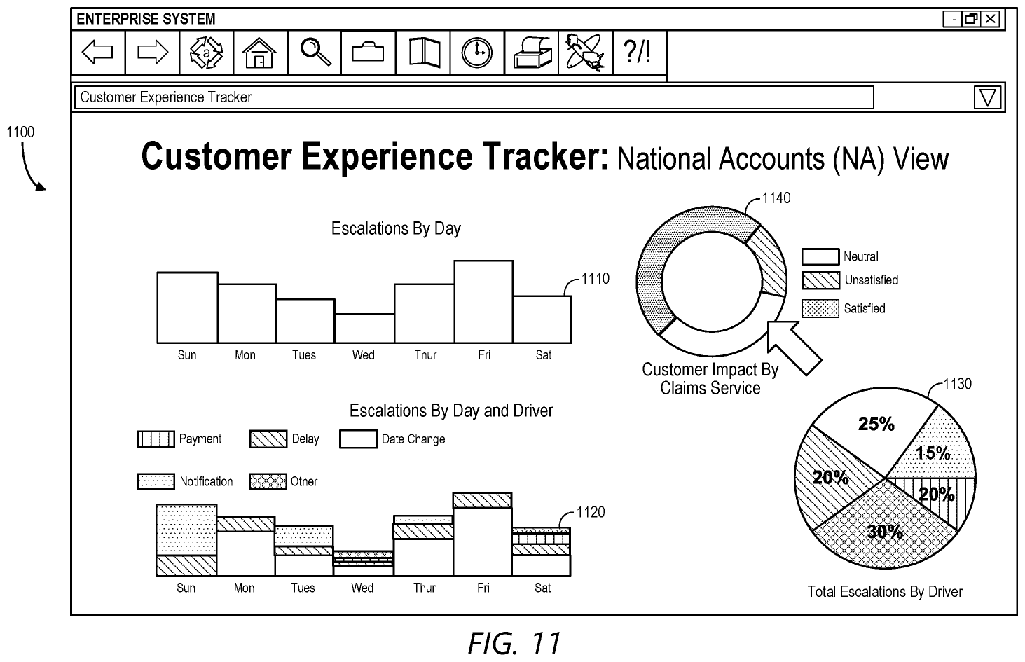

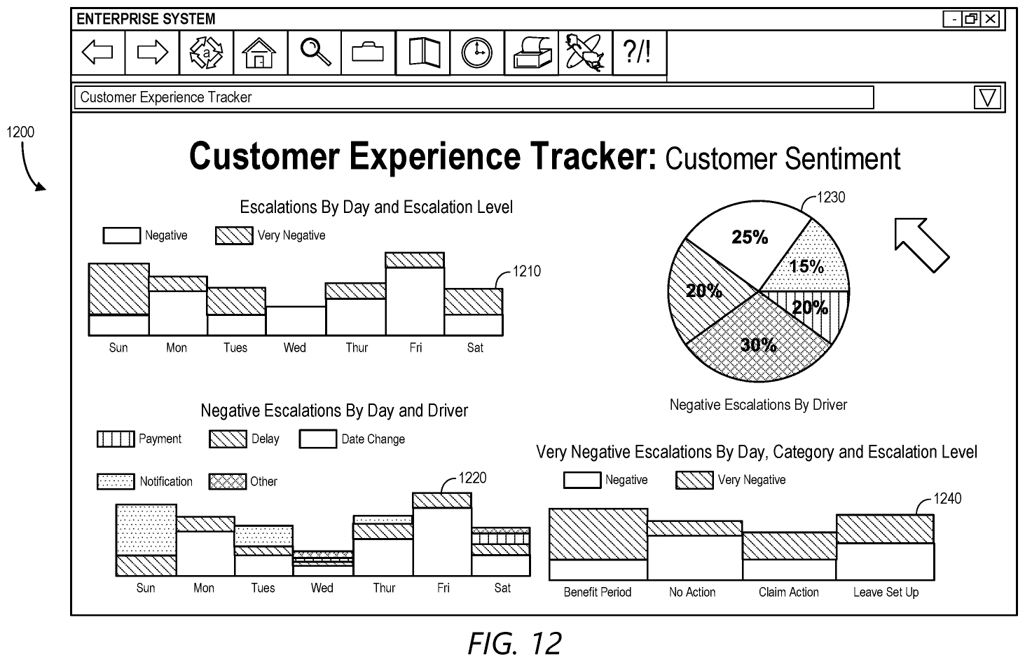

FIG. 11 is an account (e.g., for national, regional, or priority accounts) view display 1100 according to some embodiments. The display 1100 includes bar charts showing escalations by day 1110 and escalations by day and driver 1120 and a pie charts showing total escalations by driver 1130 and overall customer impact by claims service 1140. Although FIG. 11 illustrates a display 1100 broken down by type of account, note that embodiments might employ any other type of filter (e.g., by a producer or insurance broker, insurance agent, particular ZIP code, etc.). FIG. 12 is a customer sentiment display 1200 in accordance with some embodiments. In particular, the display 1200 includes bar charts showing escalations by day and escalation level 1210 (e.g., letting the user focus or escalations that are negative or very negative), negative escalations by day and drive 1220, and very negative escalations by day, category (e.g., those associated with benefit periods, leave set up, etc.), and escalation level 1240. A pie chart 1230 shows all negative escalations by deriver.

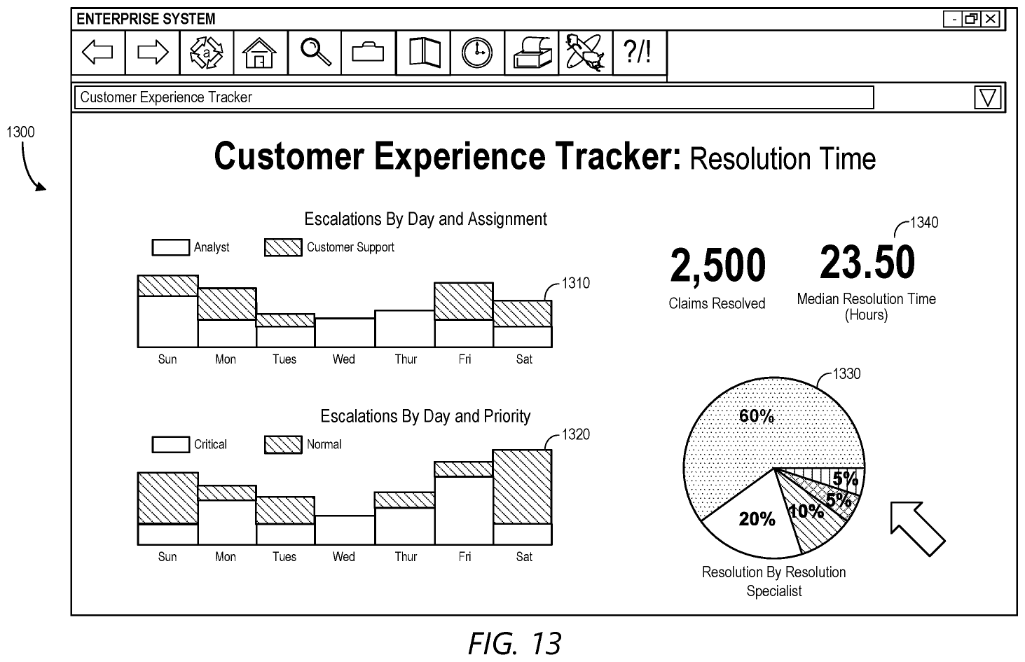

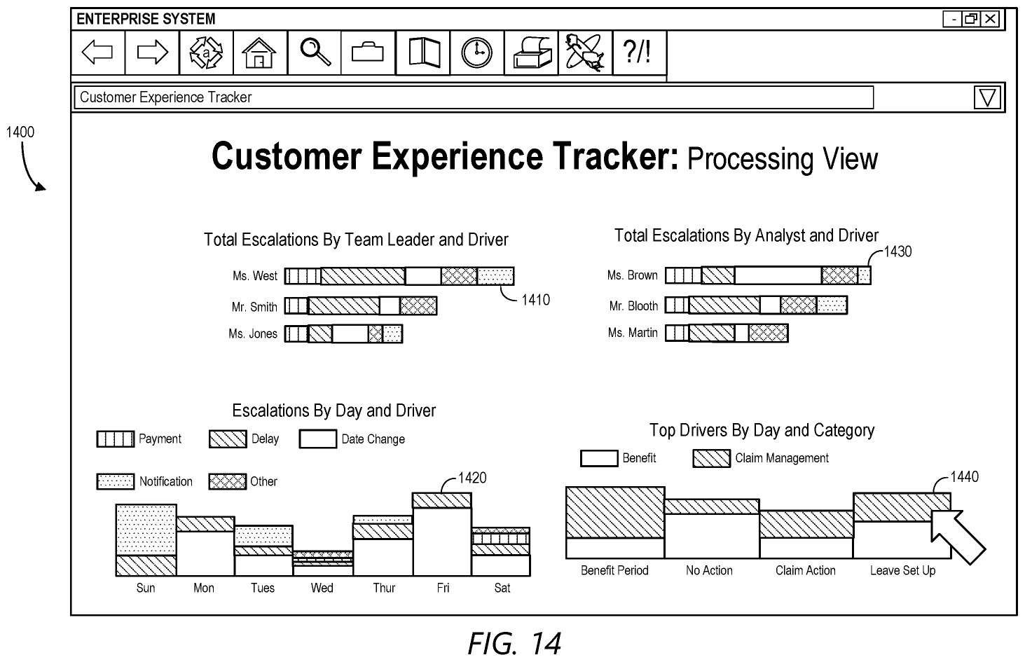

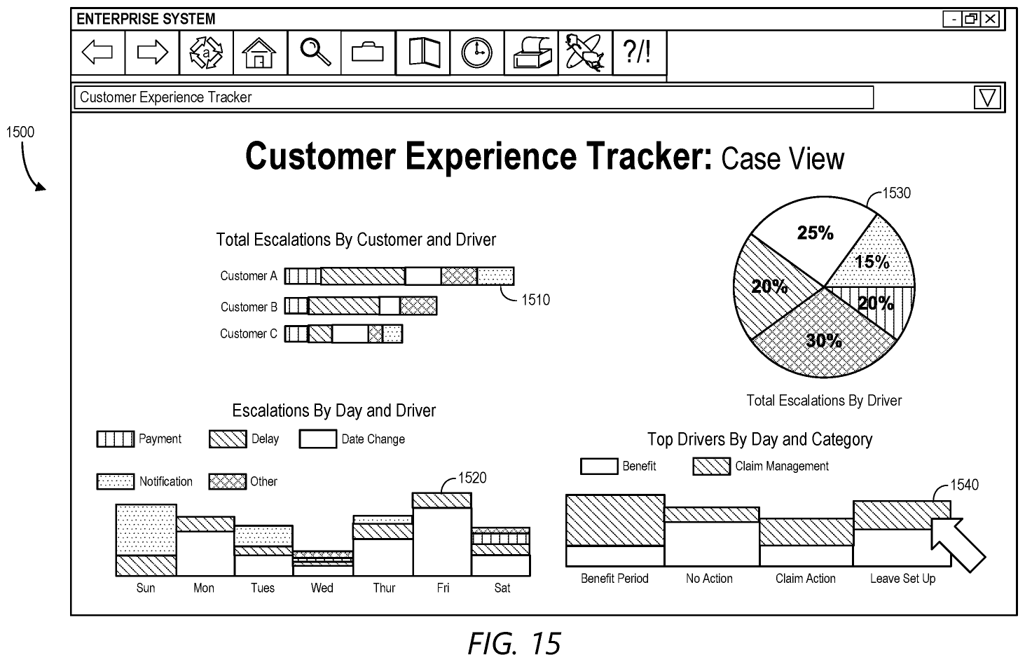

FIG. 13 is a time-to-resolution display 1300 according to some embodiments. The display 1300 includes bar charts showing escalations by day and assignment 1310 (e.g., to an analyst or customer support) and escalations by day and priority 1320 (e.g., critical or normal escalations). A pie chart shows resolutions by resolution specialist 1330 and numerical values 1340 provide an overall number of claims that have been resolved and a median time-to-resolve (in hours). FIG. 14 is a processing view display 1400 in accordance with some embodiments. The display 1400 includes bar charts showing total escalations by team leader and driver 1410 and escalations by day and driver 1420. Moreover, bar charts show total escalations by an analyst and driver 1430 and top drivers by date and category 1440. FIG. 15 is a case view display 1500 according to some embodiments. The case view display 1500 includes bar charts shown total escalations by customer and driver 1510, escalations by day and driver 1520, and top drivers by day and category 1540. A pie chart displays total escalations by driver 1530.

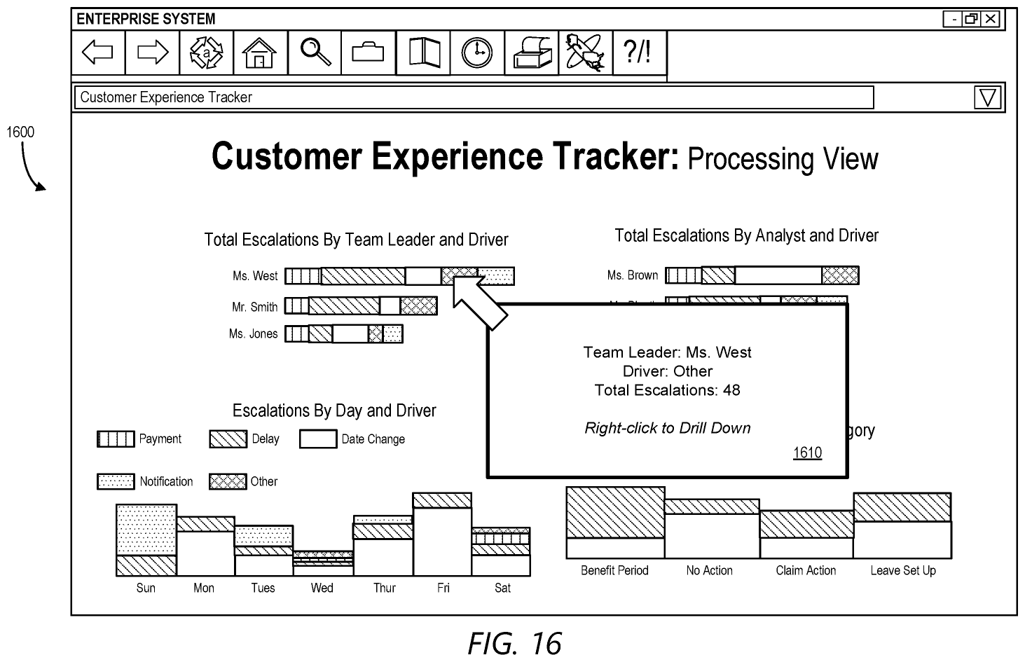

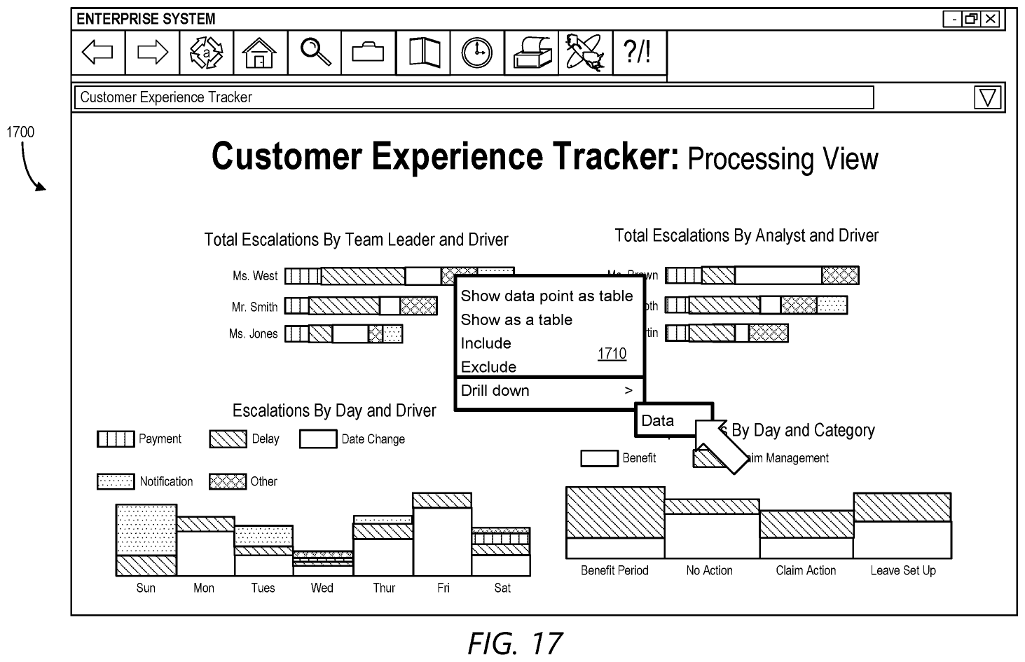

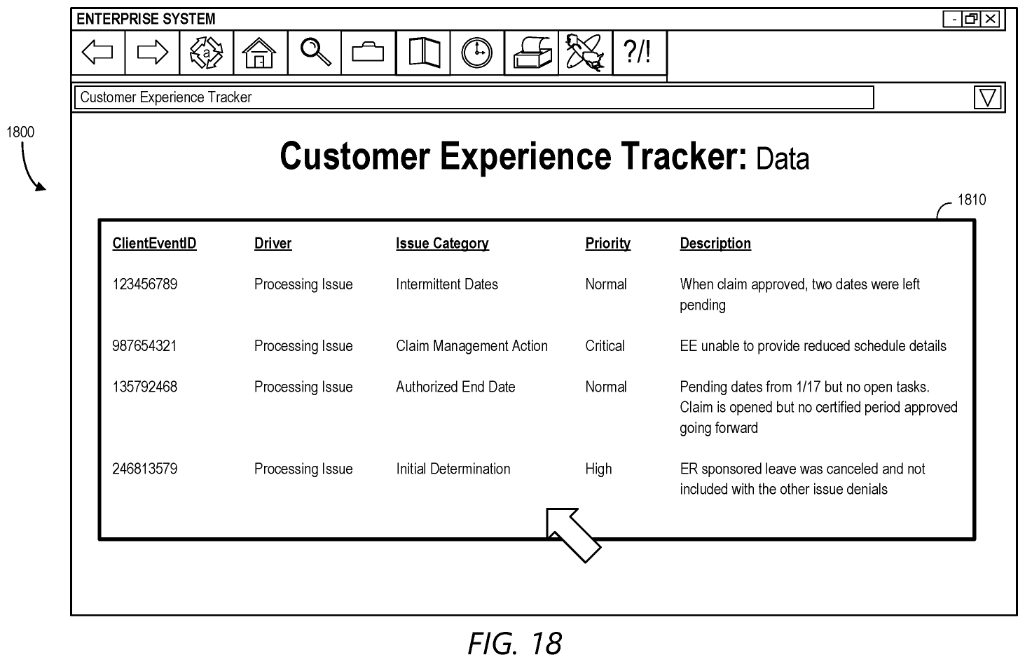

According to some embodiments, a user may select portions of a display to access or “drill down” into the information behind that graphical element. For example, FIGS. 16 and 17 illustrate drill down options in accordance with some embodiments. In FIG. 16 shows 1600 a user who has selected a portion of a bar chart and received a popup window 1610 with information about that graphical element. Similarly, FIG. 17 shows 1700 a dropdown menu 1710 that lets the user select to show a data point as a table, include items, exclude items, drill down into the data, etc. Selecting to drill down into the data may result in FIG. 18 is an event data display 1800 in accordance with some embodiments. The display 1800 includes a table 1810 showing, for each of a plurality of client event identifiers, a driver, an issue category, a priority, a description, etc.

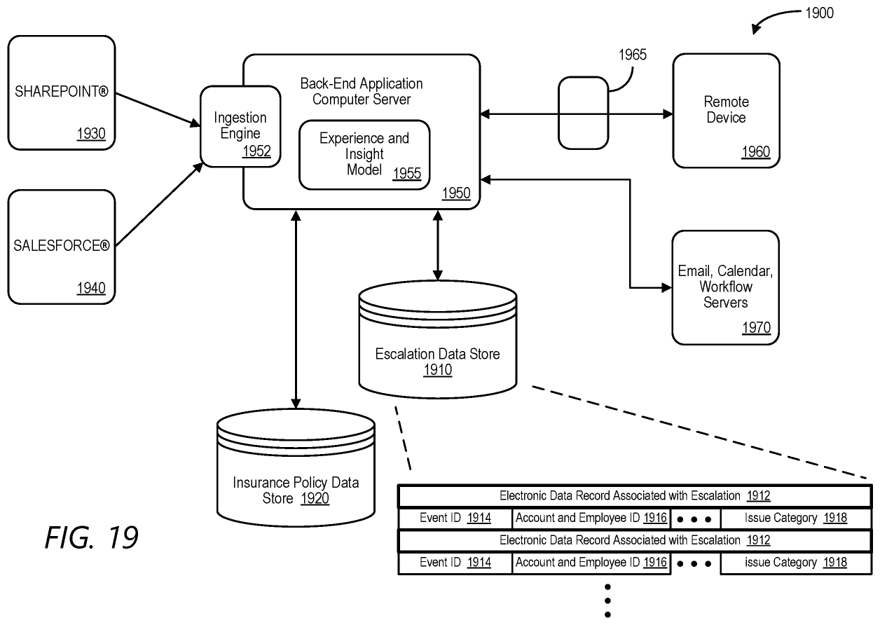

FIG. 19 is a more detailed system 1900 according to some embodiments. As before, the system 1900 includes a back-end application computer server 1950 that may access information in an escalation data store 1910 (e.g., storing a set of electronic records associated with escalations 1912, each record including, for example, an event identifier 1914, account and employee identifiers 1916, issue categories 1918, etc.). The back-end application computer server 1950 may also store information into other data stores, such as an insurance policy data store 1920, and utilize an ingestion engine 1952 and experience/insight model 1955 to exchange and process customer interactions (e.g., daily/weekly data sweeps or on-demand changes) and view, analyze, and/or update the electronic records based on information from SHAREPOINT® system 1930, a SALESFORCE® system 1940, etc. The back-end application computer server 1950 may also exchange information with a remote device 1960 (e.g., via a firewall 1965). According to some embodiments, the back-end application computer server 1950 may interact with an email server (e.g., to automatically establish communication links and/or transmit electronic messages based on interactions), a calendar server (e.g., to automatically schedule tasks or communications based on interactions), and/or a workflow server 1970 (e.g., to initiate actions by employees or programs of the enterprise based on interactions and insights).

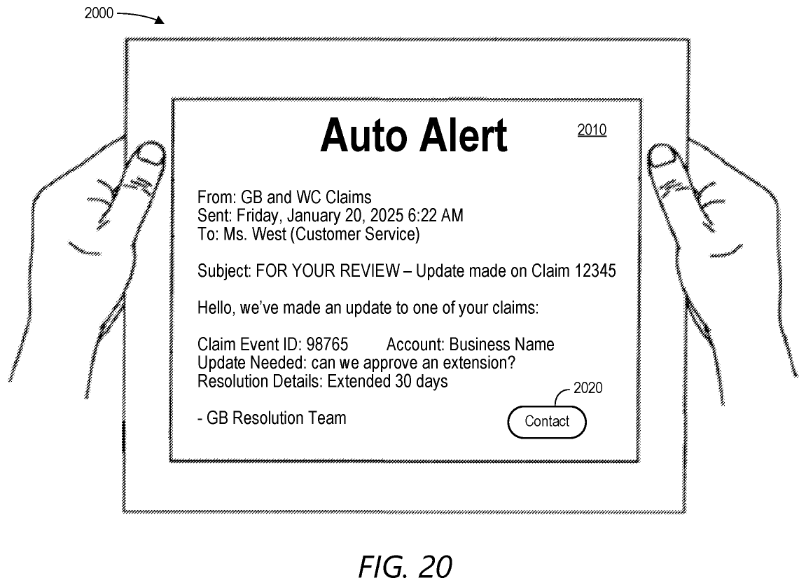

For example, FIG. 20 is an automatically generated entity interaction communication according to some embodiments. Here, a tablet computer 2000 is displays an auto alert message 2010 in the form of an email providing information about an update that has been made to a claim associated with a customer interaction. In some cases, interaction parameters include a communication address and a back-end application computer server may automatically create and transmit a leave request or other notification to the communication address (e.g., and a response to that message may be initiated via a “Contact” icon 2020). The communication address might be associated with, for example, an email address, a telephone number (e.g., to send a text message), a user name and password (e.g., to send a message via a portal), a postal address (e.g., to mail a postal letter), etc.

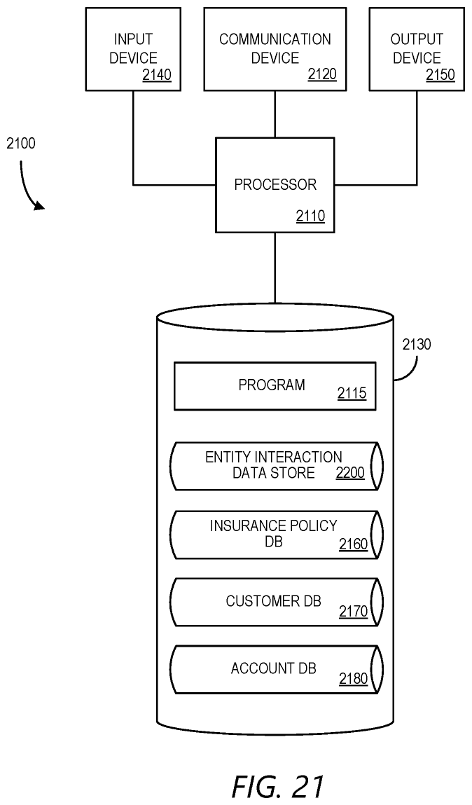

The embodiments described herein may be implemented using any number of different hardware configurations. For example, FIG. 21 illustrates an apparatus 2100 that may be, for example, associated with the systems 200, 1900 described with respect to FIGS. 2 and 19, respectively. The apparatus 2100 comprises a processor 2110, such as one or more commercially available Central Processing Units (“CPUs”) in the form of one-chip microprocessors, coupled to a communication device 2120 configured to communicate via a communication network (not shown in FIG. 21). The communication device 2120 may be used to communicate, for example, with one or more remote third-party devices, underwriting platforms, web-based tools, administrators, insurance agents, and/or communication devices (e.g., PCs and smartphones). Note that communications exchanged via the communication device 2120 may utilize security features, such as those between a public internet user and an internal network of an insurance company and/or an enterprise. The security features might be associated with, for example, web servers, firewalls, and/or PCI infrastructure. The apparatus 2100 further includes an input device 2140 (e.g., a mouse and/or keyboard to enter information about customer interactions, risk relationship rules or preferences, alert triggers, etc.) and an output device 2150 (e.g., to output reports regarding risk relationships, interaction events, machine learning algorithms, recommendations, alerts, etc.).

The processor 2110 also communicates with a storage device 2130. The storage device 2130 may comprise any appropriate information storage device, including combinations of magnetic storage devices (e.g., a hard disk drive), optical storage devices, mobile telephones, and/or semiconductor memory devices. The storage device 2130 stores a program 2115 and/or a risk relationship tool or application for controlling the processor 2110. The processor 2110 performs instructions of the program 2115, and thereby operates in accordance with any of the embodiments described herein. For example, the processor 2110 may associate selected interaction identifiers with selected accounts having risk relationships with an enterprise. The processor 2110 may then retrieve interaction parameters and risk relationship parameters and provide the retrieved interactions parameters to an enterprise predictive model that outputs an interaction insight result. The processor 2110 may also facilitate an exchange of data with a remote device to support interactive user interface displays that include information about the interaction insight result.

The program 2115 may be stored in a compressed, uncompiled and/or encrypted format. The program 2115 may furthermore include other program elements, such as an operating system, a database management system, and/or device drivers used by the processor 2110 to interface with peripheral devices.

As used herein, information may be “received” by or “transmitted” to, for example: (i) the apparatus 2100 from another device; or (ii) a software application or module within the apparatus 2100 from another software application, module, or any other source.

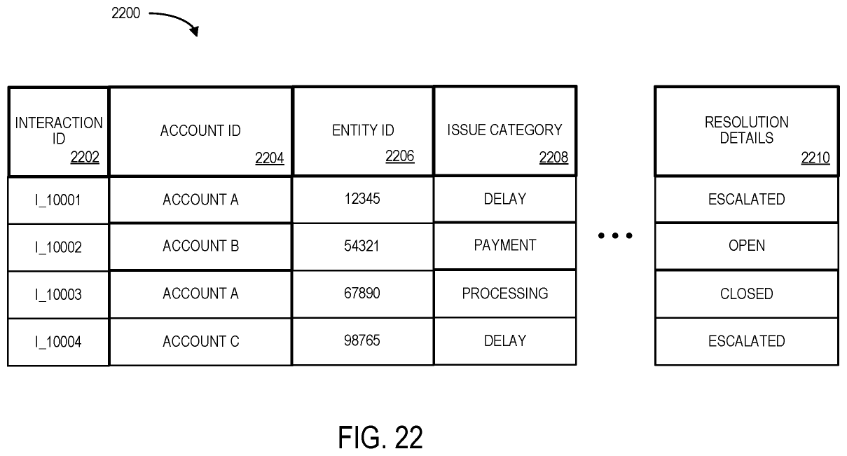

In some embodiments (such as shown in FIG. 21), the storage device 2130 further includes entity interaction data store 2200, an insurance policy database 2160, a customer database 2170, and an account database 2180. An example of a database that might be used in connection with the apparatus 2100 will now be described in detail with respect to FIG. 22. Note that the database described herein is only an example, and additional and/or different information may be stored therein. Moreover, various databases might be split or combined in accordance with any of the embodiments described herein. For example, the entity interaction data store 2200 and insurance policy database 2160 might be combined and/or linked to each other within the program 2115.

Referring to FIG. 22, a table is shown that represents the entity interaction data store 2200 that may be stored at the apparatus 2100 according to some embodiments. The table may include, for example, entries associated with different types customer interactions, escalations, and/or resolutions. The table may also define fields 2202, 2204, 2206, 2208, 2210 for each of the entries. The fields 2202, 2204, 2206, 2208, 2210 may, according to some embodiments, specify: an interaction identifier 2202, an account identifier 2204, an entity identifier 2206, an issue category 2208, and resolution details 2210. The entity interaction data store 2200 may be created and updated, for example, based on information electrically received from various enterprise systems or user adjustment (e.g., including when a new interaction event is added or resolved) in connection with an insurer or business.

The interaction identifier 2202 may be, for example, a unique alphanumeric code identifying an interaction between a customer and an insurer (e.g., when a new leave request is provided from the customer to the insurer). The account identifier 2204 may indicate an account or business associated with that interaction and an entity identifier 2206 may indicate the particular customer who provided the leave request. The issue category 2208 may indicate a problem or situation with the request and resolution details 2210 may show how the request has been (or will be) handled.

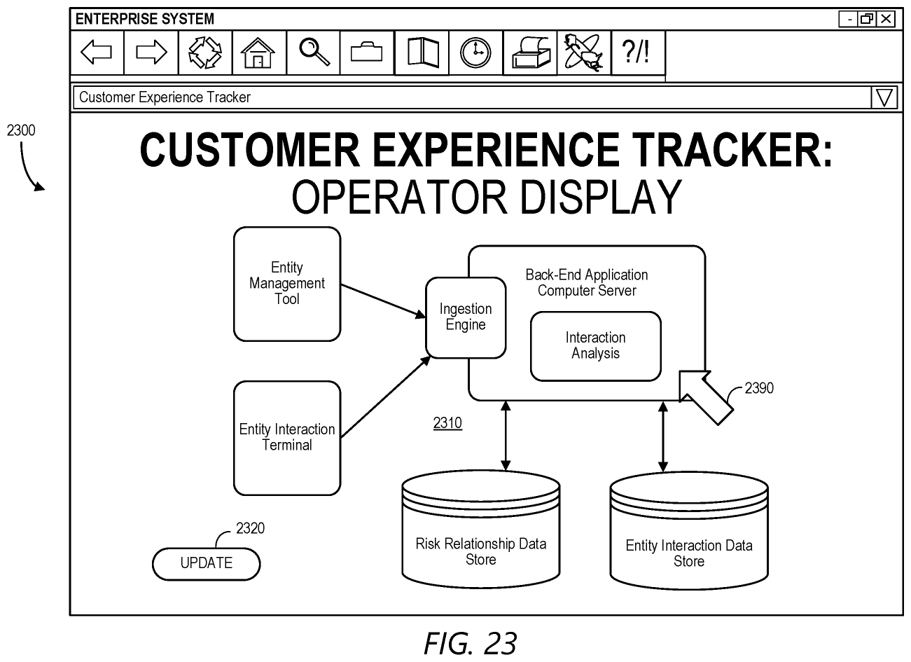

The operation of a customer experience tracker and insights dashboard may be controlled via a Graphical User Interface (“GUI”). For example, FIG. 23 is a customer experience tracker operator or administrator display 2300 including graphical representations of elements of such a tool 2310 according to some embodiments. Selection of a portion or element of the display 2300 via a touchscreen or pointer 2390 might result in the presentation of additional information about that portion or element (e.g., a popup window presenting a data source or insight model details) or let an operator or administrator enter or annotate additional information about resolution details (e.g., based on his or her experience and expertise) or mappings with data stores, entity management tools, interaction terminals, etc. An “Update” icon 2320 might result in an update the customer experience tracker.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of entities and accounts, embodiments may instead be associated with other types of businesses or employee requests in additional to and/or instead of those described herein. Similarly, although certain types of insurance, businesses, and interaction parameters were described in connection some embodiments herein, other types of insurance products and/or parameters might be used instead.

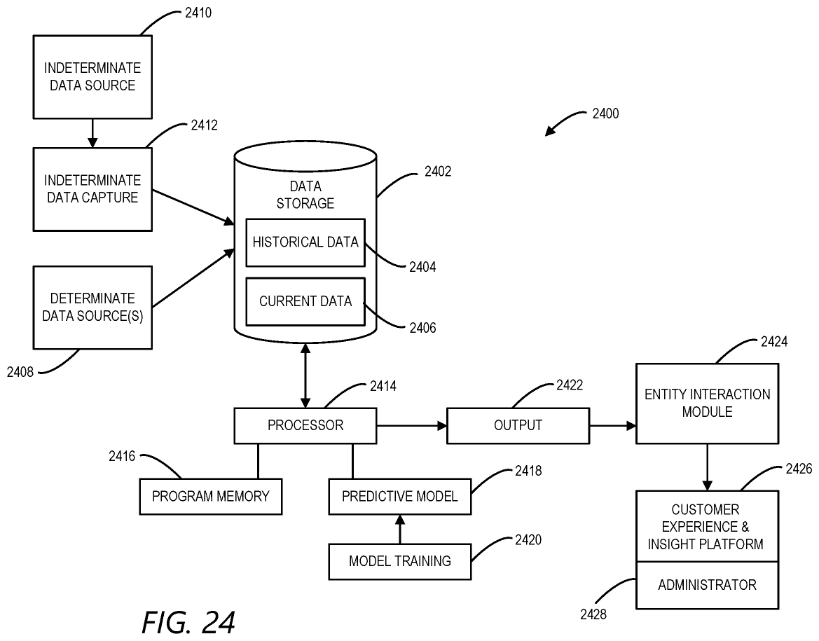

According to some embodiments, one or more machine learning algorithms and/or predictive models may be used to perform an automatic analysis of customer interaction information to generate insights. Features of some embodiments associated with a predictive model will now be described by referring to FIG. 24. FIG. 24 is a partially functional block diagram that illustrates aspects of a computer system 2400 provided in accordance with some embodiments of the invention. For present purposes it will be assumed that the computer system 2400 is operated by an insurance company (not separately shown) for the purpose of supporting automated insight generation (e.g., to streamline the collection of and use of interaction information). According to some embodiments, the third-party data and/or risk relationship data may also be used to supplement and leverage the computer system 2400.

The computer system 2400 includes a data storage module 2402. In terms of its hardware the data storage module 2402 may be conventional, and may be composed, for example, by one or more magnetic hard disk drives. A function performed by the data storage module 2402 in the computer system 2400 is to receive, store and provide access to both historical data 2404 and current data 2406. As described in more detail below, the historical data 2404 is employed to train a predictive model to provide an output that indicates an identified performance metric and/or an algorithm to score or evaluate entity interactions, and the current data 2406 is thereafter analyzed by the predictive model. Moreover, as time goes by, and results become known from processing current entity interactions, at least some of the current decisions may be used to perform further training of the predictive model. Consequently, the predictive model may thereby adapt itself to changing conditions.

Either the historical data 2404 or the current data 2406 might include, according to some embodiments, determinate and indeterminate data. As used herein and in the appended claims, “determinate data” refers to verifiable facts such as an age of employee; an employee job type; an insurance policy date or other date; a time of day; a day of the week; a geographic location, an address or ZIP code; and an insurance policy number.

As used herein, “indeterminate data” refers to data or other information that is not in a predetermined format and/or location in a data record or data form. Examples of indeterminate data include information from web sites, narrative speech or text, information in descriptive notes fields and signal characteristics in audible voice data files, etc.

The determinate data may come from one or more determinate data sources 2408 that are included in the computer system 2400 and are coupled to the data storage module 2402. The determinate data may include “hard” data like an entity name, date of incorporation, issue driver, insurance policy number, address, an analyst decision, etc. One possible source of the determinate data may be the insurance company's policy database (not separately indicated).

The indeterminate data may originate from one or more indeterminate data sources 2410 and may be extracted from raw files or the like by one or more indeterminate data capture modules 2412. Both the indeterminate data source(s) 2410 and the indeterminate data capture module(s) 2412 may be included in the computer system 2400 and coupled directly or indirectly to the data storage module 2402. Examples of the indeterminate data source(s) 2410 may include data storage facilities for big data streams, document images, text files, and web pages. Examples of the indeterminate data capture module(s) 2412 may include one or more optical character readers, a speech recognition device (i.e., speech-to-text conversion), a computer or computers programmed to perform Natural Language Processing (“NLP”), a computer or computers programmed to identify and extract information from images or video, a computer or computers programmed to detect key words in text files, and a computer or computers programmed to detect indeterminate data regarding an employee such as a medical file, etc.

The computer system 2400 also may include a computer processor 2414. The computer processor 2414 may include one or more conventional microprocessors and may operate to execute programmed instructions to provide functionality as described herein. Among other functions, the computer processor 2414 may store and retrieve historical insurance data 2404 and current data 2406 in and from the data storage module 2402. Thus, the computer processor 2414 may be coupled to the data storage module 2402.

The computer system 2400 may further include a program memory 2416 that is coupled to the computer processor 2414. The program memory 2416 may include one or more fixed storage devices, such as one or more hard disk drives, and one or more volatile storage devices, such as RAM devices. The program memory 2416 may be at least partially integrated with the data storage module 2402. The program memory 2416 may store one or more application programs, an operating system, device drivers, etc., all of which may contain program instruction steps for execution by the computer processor 2414.

The computer system 2400 further includes a predictive model component 2418. In certain practical embodiments of the computer system 2400, the predictive model component 2418 may effectively be implemented via the computer processor 2414, one or more application programs stored in the program memory 2416, and computer stored as a result of training operations based on the historical data 2404 (and possibly also data received from a third party). In some embodiments, data arising from model training may be stored in the data storage module 2402, or in a separate computer store (not separately shown). A function of the predictive model component 2418 may be to determine appropriate performance metric scores, scoring algorithms, entity interaction rules or decisions, etc. The predictive model component may be directly or indirectly coupled to the data storage module 2402.

The predictive model component 2418 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein.

Still further, the computer system 2400 includes a model training component 2420. The model training component 2420 may be coupled to the computer processor 2414 (directly or indirectly) and may have the function of training the predictive model component 2418 based on the historical data 2404 and/or information about entities. (As will be understood from previous discussion, the model training component 2420 may further train the predictive model component 2418 as further relevant data becomes available.) The model training component 2420 may be embodied at least in part by the computer processor 2414 and one or more application programs stored in the program memory 2416. Thus, the training of the predictive model component 2418 by the model training component 2420 may occur in accordance with program instructions stored in the program memory 2416 and executed by the computer processor 2414.

In addition, the computer system 2400 may include an output device 2422. The output device 2422 may be coupled to the computer processor 2414. A function of the output device 2422 may be to provide an output that is indicative of (as determined by the trained predictive model component 2418) particular customer interaction scores, interaction rules or decisions, etc. The output may be generated by the computer processor 2414 in accordance with program instructions stored in the program memory 2416 and executed by the computer processor 2414. More specifically, the output may be generated by the computer processor 2414 in response to applying the data for the current simulation to the trained predictive model component 2418. The output may, for example, be a numerical estimate, a likelihood within a predetermined range of numbers, a defined series of interaction responses, automatically generated alerts or suggestions, etc. In some embodiments, the output device may be implemented by a suitable program or program module executed by the computer processor 2414 in response to operation of the predictive model component 2418.

Still further, the computer system 2400 may include an entity interaction module 2424. The entity interaction module 2424 may be implemented in some embodiments by a software module executed by the computer processor 2414. The entity interaction module 2424 may have the function of rendering a portion of the display on the output device 2422. Thus, the entity interaction module 2424 may be coupled, at least functionally, to the output device 2422. In some embodiments, for example, the entity interaction module 2424 may direct communications with an enterprise by referring to an administrator 2428 via a customer experience and insight platform 2426, messages customized and/or generated by the predictive model component 2418 (e.g., suggesting interaction workflows, alerts or appropriate actions, etc.) and found to be associated with various parties or types of parties. In some embodiments, these results may be provided to the administrator 2428 who may also be tasked with determining whether or not performance may be improved.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. An interaction tracking system implemented via a back-end application computer server of an enterprise, comprising:
(a) an entity interaction data store that contains electronic records associated with a plurality of interaction identifiers, and, for each interaction identifier, an account identifier, an entity identifier, and interaction parameters;
(b) a risk relationship data store that contains electronic records associated with a plurality of accounts having risk relationships with the enterprise, and, for each account, an account identifier and risk relationship parameters;
(c) the back-end application computer server, coupled to the entity interaction data store and the risk relationship data store, including:
a computer processor, and
a computer memory coupled to the computer processor and storing instructions that, when executed by the computer processor, cause the back-end application computer server to:
associate selected interaction identifiers in the entity interaction data store with selected accounts having risk relationships with the enterprise,
based on the selected interaction identifiers, retrieve interaction parameters from the entity interaction data store and risk relationship parameters from the risk relationship data store, and
provide the retrieved interactions parameters to an enterprise predictive model that outputs an interaction insight result; and
(d) a communication port coupled to the back-end application computer server to facilitate an exchange of data with a remote device to support interactive user interface displays that include information about the interaction insight result.

2. The system of claim 1, wherein the interactive user interface displays include at least one of: (i) a twelve month macro display, (ii) a daily activity display, (iii) a product view display, (iv) an account view display, (v) an entity sentiment display, (vi) a resolution time display, (vii) a processing view display, (viii) a case view display, and (ix) an underlying data display.

3. The system of claim 1, wherein the interaction parameters include at least one of: (i) a date, (ii) an issue category, (iii) an issue subcategory, (iv) a line of business, (v) an issue description, (vi) an analyst name, (vii) an entity sentiment, (viii) an urgency level, (ix) a status, (x) update information, (xi) an entity support assignment, and (xii) an attachment.

4. The system of claim 1, wherein the interaction parameters include at least one of: (i) a root cause category, and (ii) resolution details.

5. The system of claim 1, wherein the interaction parameters are associated with an interaction escalation driver including at least one of: (i) a date change, (ii) a delay, (iii) a payment issue, (iv) an employer inquiry, (v) a notification error, (vi) a processing issue, and (vii) a service concern.

6. The system of claim 1, wherein the enterprise is an insurer, the account identifiers are associated with businesses, the risk relationships are associated with insurance policies, and the entities are associated with customers who are employees of the businesses.

7. The system of claim 6, wherein the interactions are associated with customer leave requests.

8. The system of claim 7, wherein the customer leave requests are associated with at least one of: (i) absence management, (ii) workers' compensation, (iii) Short Term Disability (“STD”), (iv) Long Term Disability (“LTD”), and (v) paid family leave.

9. The system of claim 8, wherein escalations are assigned to at least one of: (i) a team leader, and (ii) an analyst.

10. The system of claim 9, wherein the interaction parameters include a communication address and the back-end application computer server is further to automatically create and transmit a leave request notification to the communication address.

11. The system of claim 10, wherein the communication address is associated with at least one of: (i) an email address, (ii) a telephone number, (iii) a user name and password, and (iv) a postal address.

12. An interaction tracking method implemented via a back-end application computer server of an enterprise, comprising:
associating, by a computer processor of the back-end application computer server, selected interaction identifiers in an entity interaction data store with selected accounts having risk relationships with the enterprise, wherein the entity interaction data store contains electronic records associated with a plurality of interaction identifiers, and, for each interaction identifier, an account identifier, an entity identifier, and interaction parameters;
based on the selected interaction identifiers, retrieving, by a computer processor of the back-end application computer server, interaction parameters from the entity interaction data store and risk relationship parameters from the risk relationship data store;
providing the retrieved interactions parameters to an enterprise predictive model that outputs an interaction insight result; and
exchanging data with a remote device to support interactive user interface displays that include information about the interaction insight result.

13. The method of claim 12, wherein the interactive user interface displays include at least one of: (i) a twelve month macro display, (ii) a daily activity display, (iii) a product view display, (iv) an account view display, (v) an entity sentiment display, (vi) a resolution time display, (vii) a processing view display, (viii) a case view display, and (ix) an underlying data display.

14. The method of claim 12, wherein the interaction parameters include at least one of: (i) a date, (ii) an issue category, (iii) an issue subcategory, (iv) a line of business, (v) an issue description, (vi) an analyst name, (vii) an entity sentiment, (viii) an urgency level, (ix) a status, (x) update information, (xi) an entity support assignment, and (xii) an attachment.

15. The method of claim 12, wherein the interaction parameters include at least one of: (i) a root cause category, and (ii) resolution details.

16. The method of claim 12, wherein the interaction parameters are associated with an interaction escalation driver including at least one of: (i) a date change, (ii) a delay, (iii) a payment issue, (iv) an employer inquiry, (v) a notification error, (vi) a processing issue, and (vii) a service concern.

17. A non-transitory, computer-readable medium storing instructions, that, when executed by a processor, cause the processor to perform an interaction tracking method implemented via a back-end application computer server of an enterprise, the method comprising:
associating, by a computer processor of the back-end application computer server, selected interaction identifiers in an entity interaction data store with selected accounts having risk relationships with the enterprise, wherein the entity interaction data store contains electronic records associated with a plurality of interaction identifiers, and, for each interaction identifier, an account identifier, an entity identifier, and interaction parameters;
based on the selected interaction identifiers, retrieving, by a computer processor of the back-end application computer server, interaction parameters from the entity interaction data store and risk relationship parameters from the risk relationship data store;
providing the retrieved interactions parameters to an enterprise predictive model that outputs an interaction insight result; and
exchanging data with a remote device to support interactive user interface displays that include information about the interaction insight result.

18. The medium of claim 17, wherein the enterprise is an insurer, the account identifiers are associated with businesses, the risk relationships are associated with insurance policies, and the entities are associated with customers who are employees of the businesses.

19. The medium of claim 18, wherein the interactions are associated with customer leave requests.

20. The medium of claim 19, wherein the customer leave requests are associated with at least one of: (i) absence management, (ii) workers' compensation, (iii) Short Term Disability (“STD”), (iv) Long Term Disability (“LTD”), and (v) paid family leave.

21. The medium of claim 20, wherein escalations are assigned to at least one of: (i) a team leader, and (ii) an analyst.

22. The medium of claim 21, wherein the interaction parameters include a communication address and the back-end application computer server is further to automatically create and transmit a leave request notification to the communication address.

23. The medium of claim 22, wherein the communication address is associated with at least one of: (i) an email address, (ii) a telephone number, (iii) a user name and password, and (iv) a postal address.
